(19) United States
(12) Patent Application Publication
(10) Pub. No.: US 2025/0138178 A1
(43) Pub. Date: May 1, 2025

(54) METHOD FOR SENSING MEASUREMENT, SENSING INITIATOR, AND STORAGE MEDIUM

(71) Applicant: GUANGDONG OPPO MOBILE TELECOMMUNICATIONS CORP., LTD., Dongguan (CN)

(72) Inventors: Ning GAO, Dongguan, Guangdong (CN); Chaoming LUO, Dongguan, Guangdong (CN); Yapu LI, Dongguan, Guangdong (CN)

(21) Appl. No.: 19/006,365

(22) Filed: Dec. 31, 2024

Related U.S. Application Data
(63) Continuation of application No. PCT/CN2022/120369, filed on Sep. 21, 2022.

(51) Int. Cl. G01S 13/76; H04W 4/38; H04W 84/12

(52) U.S. Cl. CPC G01S 13/765; G01S 13/767; H04W 4/38; H04W 84/12

(57) ABSTRACT

Provided is a method for sensing measurement. The method is applicable to a sensing initiator, and includes: transmitting a sensing request frame to at least one sensing responder using a first modulation and coding scheme (MCS) in a parallel coordinated monostatic measurement; and receiving a sensing response frame transmitted by the at least one sensing responder using the first MCS, wherein the first MCS is an MCS specified in a protocol.

### CROSS-REFERENCE TO RELATED APPLICATION

This application is a continuation of International Application No. PCT/CN2022/120369, filed Sep. 21, 2022, the entire disclosure of which is incorporated herein by reference.

### TECHNICAL FIELD

Embodiments of the present disclosure relate to the technical field of sensing measurement, and in particular, relate to a method and apparatus for sensing measurement, and a device, a chip, and a storage medium thereof.

### BACKGROUND

Wireless local area network (WLAN) sensing refers to a technology for sensing a person or object in an environment by measuring changes of WLAN signals during scattering and/or reflection by the person or object.

### SUMMARY

Embodiments of the present disclosure provide a method for sensing measurement, a sensing initiator, and a storage medium thereof. The technical solutions are as follows.

According to an aspect of the embodiments of the present disclosure, a method for sensing measurement is provided. The method is applicable to a sensing initiator, and includes:
transmitting a sensing request frame to at least one sensing responder using a first modulation and coding scheme (MCS) in a parallel coordinated monostatic measurement; and
receiving a sensing response frame transmitted by the at least one sensing responder using the first MCS, wherein the first MCS is an MCS specified in a protocol.

According to an aspect of the embodiments of the present disclosure, a sensing initiator is provided. The sensing initiator includes: a processor, a transceiver connected to the processor, and a memory storing one or more executable instructions by the processor; wherein the processor, when loading and executing the one or more executable instructions, causes the sensing initiator to perform the method for sensing measurement in the above embodiments.

According to some embodiments of the present disclosure, a non-transitory computer-readable storage medium is provided, wherein the one or more computer programs, when loaded and run by a sensing initiator, cause the sensing initiator to perform the method for sensing measurement in the above embodiments.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a block diagram of a sensing measurement system according to some embodiments of the present disclosure;

FIG. 2 is a schematic diagram of millimeter wave sensing types according to some embodiments of the present disclosure;

FIG. 3 is a schematic diagram of a procedure of millimeter wave sensing according to some embodiments of the present disclosure;

FIG. 4 is a schematic diagram of a sequential mode instance of millimeter wave coordinated monostatic sensing measurement according to some embodiments of the present disclosure;

FIG. 5 is a schematic diagram of a parallel mode instance of millimeter wave coordinated monostatic sensing measurement according to some embodiments of the present disclosure;

FIG. 6 is a schematic diagram of a frame format of a Directional Multi-Gigabit (DMG) Sensing Measurement Setup element according to some embodiments of the present disclosure;

FIG. 7 is a schematic diagram of a format of a beamforming frame according to some embodiments of the present disclosure;

FIG. 8 is a schematic diagram of a format of a sensing request frame according to some embodiments of the present disclosure;

FIG. 9 is a schematic diagram of a format of a sensing response frame according to some embodiments of the present disclosure;

FIG. 10 is a schematic diagram of a format of a sensing poll frame according to some embodiments of the present disclosure;

FIG. 11 is a schematic diagram of an enhanced DMG (EDMG) multi-static sensing physical layer protocol data unit (PPDU) according to some embodiments of the present disclosure;

FIG. 12 is a schematic diagram of a multi-static sensing measurement instance according to some embodiments of the present disclosure;

FIG. 13 is a schematic diagram of a parallel coordinated monostatic sensing measurement instance in some practices according to some embodiments of the present disclosure;

FIG. 14 is a flowchart of a method for sensing measurement according to some embodiments of the present disclosure;

FIG. 15 is a flowchart of a method for sensing measurement according to some embodiments of the present disclosure;

FIG. 16 is a schematic diagram of a method for sensing measurement according to some embodiments of the present disclosure;

FIG. 17 is a flowchart of a method for sensing measurement according to some embodiments of the present disclosure;

FIG. 18 is a flowchart of a method for sensing measurement according to some embodiments of the present disclosure;

FIG. 19 is a schematic diagram of a method for sensing measurement according to some embodiments of the present disclosure;

FIG. 20 is a schematic diagram of a method for sensing measurement according to some embodiments of the present disclosure;

FIG. 21 is a schematic diagram of a method for sensing measurement according to some embodiments of the present disclosure;

FIG. 22 is a block diagram of an apparatus for sensing measurement according to some embodiments of the present disclosure;

FIG. 23 is a block diagram of an apparatus for sensing measurement according to some embodiments of the present disclosure;

FIG. 24 is a block diagram of an apparatus for sensing measurement according to some embodiments of the present disclosure;

FIG. 25 is a block diagram of an apparatus for sensing measurement according to some embodiments of the present disclosure; and

FIG. 26 is a schematic structural diagram of a sensing measurement device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings. The exemplary embodiments are described in detail herein, and examples are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to limit the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” and the like may be used herein to describe various pieces of information, and such information should not be limited to these terms. These terms are only used to distinguish one type of information from another. For example, a first parameter may also be referred to as a second parameter, and similarly, a second parameter is also referred to as a first parameter, without departing from the scope of the present disclosure. The word “if,” as used herein, may be interpreted as “in the case that,” “in the case of,” or “in response to determining that,” depending on the context.

Some terms in the embodiments of the present disclosure are described as follows.

WLAN sensing is a technology for sensing a person or an object in an environment by measuring changes in WLAN signals during scattering and/or reflection by the person or the object. That is, the WLAN sensing measures and senses the surrounding environment by wireless signals, such that various functions can be achieved, such as detection of whether someone intrudes/moves/falls indoors, gesture recognition, and establishment of three-dimensional spatial images.

An association identifier (AID) is configured to identify a terminal that has established an association with an access point.

WLAN devices that participate in the WLAN sensing may include a sensing initiator, a sensing responder, a sensing transmitter, and a sensing receiver.

The sensing initiator is also referred to as a sensing session initiator, a sensing initiating device, and an initiator, and the sensing initiator is a device that initiates sensing measurement and desires to learn a sensing result.

The sensing responder is also referred to as a sensing session responder, a sensing responding device, and a responder, and the sensing responder is a device that participates in the sensing measurement and is not a sensing initiating device.

The sensing transmitter is also referred to as a sensing signal transmitter, a sensing transmitting device, a sensing transmitting apparatus, and a transmitter, and the sensing transmitter is a device that transmits a sensing PPDU.

The sensing receiver is also referred to as a sensing signal receiver, a sensing receiving device, a sensing receiving apparatus, and a receiver. The sensing receiver is a device that receives an echo signal. The echo signal is acquired by scattering and/or reflecting for the sensing physical layer protocol data unit transmitted by the sensing transmitter by people or objects.

A WLAN terminal plays one or more roles in the sensing measurement. For example, the sensing initiator is only a sensing initiator, a sensing transmitter, a sensing receiver, or both a sensing transmitter and a sensing receiver. The devices described above are collectively referred to as a sensing measurement device.

Next, the technical background related to the embodiments of the present disclosure is described as follows.

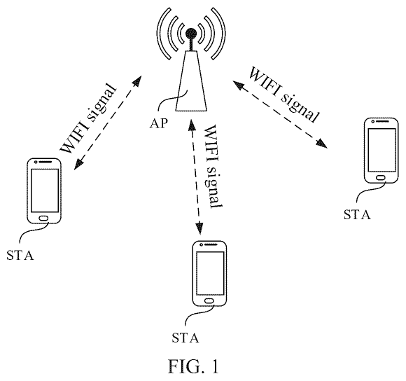

FIG. 1 is a block diagram of a sensing measurement system according to some embodiments of the present disclosure. The sensing measurement system includes a terminal and a terminal, or a terminal and a network device, or an access point (AP) and a station (STA), which is not limited in the present disclosure. In the present disclosure, the sensing measurement system is illustrated as including an AP and an STA.

In some scenarios, the AP is also referred to as an AP STA, which means that, in a certain sense, the AP is also a type of STA. In some scenarios, the STA is also referred to as a non-AP STA. In some embodiments, STAs include an AP STA and a non-AP STA.

The communications within the communication system involve communications between an AP and a non-AP STA, communications between non-AP STAs, or communications between an STA and a peer STA. The peer STA refers to a device in peer communication with an STA. For example, the peer STA may be an AP or a non-AP STA.

The AP is a bridge to connect the wired network and the wireless network, and mainly functions to connect various wireless network clients and access the wireless network to the Ethernet. The AP device is a terminal device (for example, a mobile phone) or a network device (for example, a router). It should be noted that the function of the STA in the communication system is not definite or specific. For example, in some scenarios, the mobile phone serves as the non-AP STA in the case that the mobile phone is connected to the router, and the mobile phone serves as the AP in the case that the mobile phone is the hotspot of other mobile phones.

The AP and the non-AP STA are devices applicable to the Internet of vehicles, Internet of things (IoT) nodes or sensors in the IoT, and smart cameras, smart remote controls, smart water meters and the like in the smart home, sensors in the smart city, and the like.

In some embodiments, the non-AP STA supports, but is not limited to supporting an 802.11bf format. In some embodiments, the non-AP STA also supports various current and future WLAN formats of the 802.11 family, such as an 802.11ax format, an 802.11ac format, an 802.11n format, an 802.11g format, an 802.11b format, an 802.11a format, and the like.

In some embodiments, the AP is a device supporting the 802.11bf format. The AP is also a device supporting various current and future WLAN formats of the 802.11 family, such as an 802.11ax format, an 802.11ac format, an 802.11n format, an 802.11g format, an 802.11b format, an 802.11a format, and the like.

In some embodiments of the present disclosure, the STA is a mobile phone, a pad, a computer, a virtual reality (VR) device, an augmented reality (AR) device, an industrial control wireless device, a set-top box, a wireless device in self-driving, an in-vehicle communication device, a wireless device in remote medical surgery, a wireless device in smart grid, a wireless device in transportation safety, a wireless device in a smart city or smart home, a wireless communication chip/application-specific integrated circuit (ASIC)/system on chip (SoC), and the like that support the WLAN/wireless fidelity (Wi-Fi) technologies.

The WLAN supports frequency bands including, but not limited to a low frequency band (2.4 GHz, 5 GHZ, or 6 GHZ), and a high frequency band (60 GHZ).

One or more links are present between the STA and the AP.

In some embodiments, the STA and the AP support multi-band communications, such as simultaneous communications at 2.4 GHz, 5 GHZ, 6 GHZ, and 60 GHz bands, or simultaneous communications in different channels of the same frequency band (or different frequency bands), such that the communication throughput and/or reliability between devices is improved. Such devices are often referred to as multi-band devices, or multi-link devices (MLDs), and are also referred to as multi-link entities or multi-band entities. The multi-link device may be an AP device or an STA device. In the case that the multi-link device is an AP device, one or more APs are included in the multi-link device; and in the case that the multi-link device is an STA device, one or more non-AP STAs are included in the multi-link device. The multi-link device including one or more APs is also referred to as an AP, and the multi-link device including one or more non-AP STAs is also referred to as a non-AP. In the embodiments of the present disclosure, the non-AP is also referred to as an STA.

In the embodiments of the present disclosure, the AP may include a plurality of APs, the non-AP may include a plurality of STAs, a plurality of links may be formed between the APs in the AP and the STAs in the non-AP, and data communication may be performed between the APs in the AP and the corresponding STAs in the non-AP over the corresponding links.

The AP is a device deployed in a wireless local area network to provide a wireless communication function for the STA. The station may include a user equipment (UE), an access terminal, a subscriber unit, a subscriber station, a rover station, a mobile station, a remote station, a remote terminal, a mobile device, a wireless communication device, a user agent, or a user apparatus. In some embodiments, the station is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, or a wearable device, which is not limited in the embodiments of the present disclosure.

In the embodiments of the present disclosure, both the station and the access point support the Institute of Electrical and Electronic Engineers (IEEE) 802.11 standard, but not limited to the IEEE 802.11 standard. The station and the access point may support other standards related to sensing measurement, such as the IEEE 802.11 bf D0.1 standard.

In the WLAN sensing scenario, WLAN terminals involved in sensing include a sensing initiator and a sensing responder. Further, the sensing responder may be classified into a sensing transmitter and a sensing receiver. The sensing measurement is applicable to a cellular network communication system, a WLAN system, or a Wi-Fi system, which is not limited in the present disclosure. In the present disclosure, the sensing measurement is illustrated as being applied to the WLAN or Wi-Fi system.

In some embodiments, the sensing measurement in the embodiments of the present disclosure is implemented based on millimeter waves. The millimeter wave sensing types are described hereinafter.

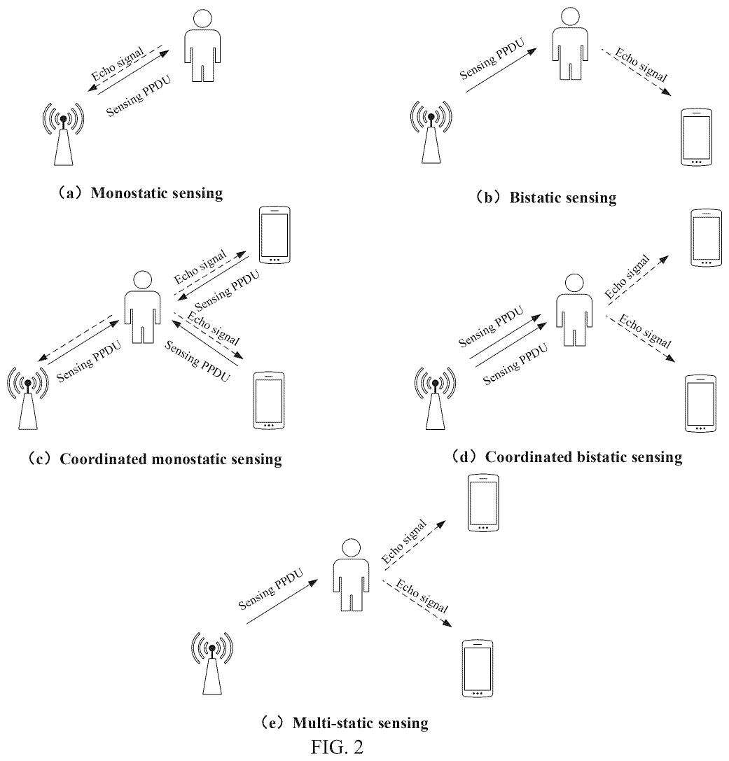

FIG. 2 is a schematic diagram of millimeter wave sensing types according to some embodiments of the present disclosure. As illustrated in FIG. 2, FIG. 2(a) shows monostatic sensing, where only one device participates in the sensing. The device senses the environment by self-transmitting a sensing PPDU and self-receiving an echo signal, similar to the operation of a conventional radar. In transmitting the sensing PPDU, the device sets an address of the transmitter and an address of the receiver of the sensing PPDU as an address of the device itself. The sensing PPDU transmitted by the device forms an echo signal upon being scattered and/or reflected by the environment, and then the device receives the echo signal based on the address of the device and senses the environment by analyzing the echo signal. FIG. 2(b) shows bistatic sensing, where two devices participate in sensing, one device transmits a sensing PPDU and the other device receives an echo signal to sense the environment. FIG. 2(c) shows coordinated monostatic sensing, where more than one device participates in sensing, each device senses the environment by self-transmitting a sensing PPDU and self-receiving an echo signal, and a sensing initiator controls all other devices to achieve coordination. FIG. 2(d) shows coordinated bistatic sensing, where more than two devices participate in sensing, that is, at least two pairs of bistatic sensing devices are present, and each transmitting device (sensing transmitter) transmits a sensing PPDU and a receiving device (sensing receiver) in the same group receives a corresponding echo signal, such that the coordinated sensing is achieved. FIG. 2(c) shows multi-static sensing, where more than two devices participate in the sensing, one transmitting device transmits a sensing PPDU, and a plurality of receiving devices simultaneously receive echo signals and complete environment sensing.

The millimeter wave sensing procedure is described hereinafter.

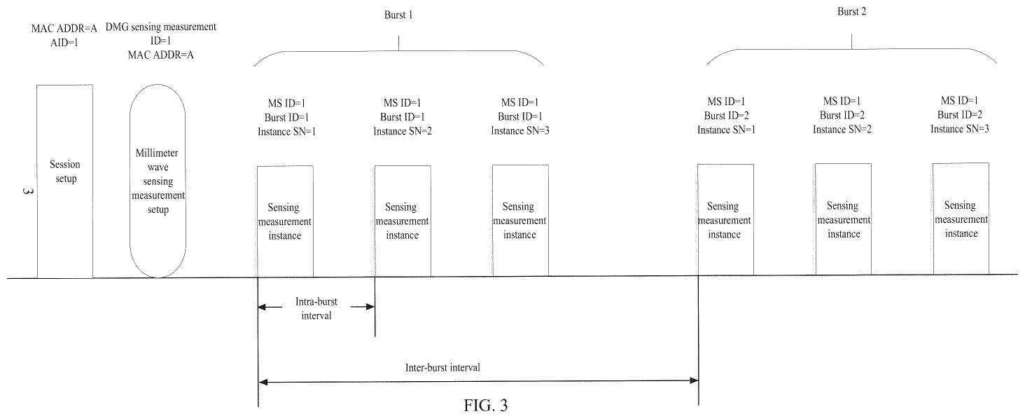

FIG. 3 is a schematic diagram of a procedure of millimeter wave sensing according to some embodiments of the present disclosure. As illustrated in FIG. 3, the procedure is a general procedure of millimeter wave sensing, where a session setup phase, a millimeter wave sensing measurement setup (DMG measurement setup) phase, and a sensing measurement phase are sequentially involved from left to right. The sensing measurement phase includes a plurality of sensing measurement bursts, and each burst includes a plurality of sensing measurement instances (DMG sensing instances). A time interval between bursts is an inter-burst interval, and a time interval between adjacent sensing measurement instances in one burst is an intra-burst interval. In FIG. 3, the MAC ADDR refers to a medium access control (MAC) address, the AID refers to an association identifier, the DMG measurement setup ID refers to a millimeter wave sensing measurement setup identifier, the MS ID refers to a measurement setup (MS) identifier, the burst ID refers to a burst identifier, and the instance sequential number (SN) refers to a sensing measurement instance identifier, which may also be referred to as a sensing instance SN. The “burst” in the above description is also referred to as a “start.”

The millimeter wave coordinated monostatic sensing measurement instance is described hereinafter.

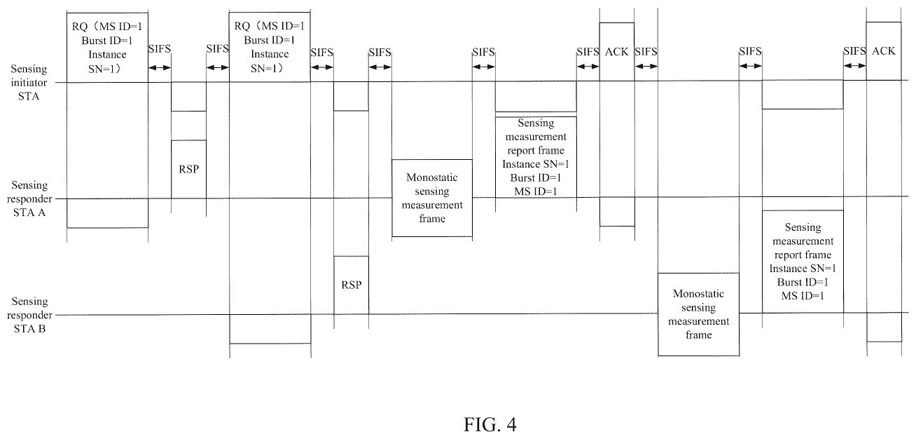

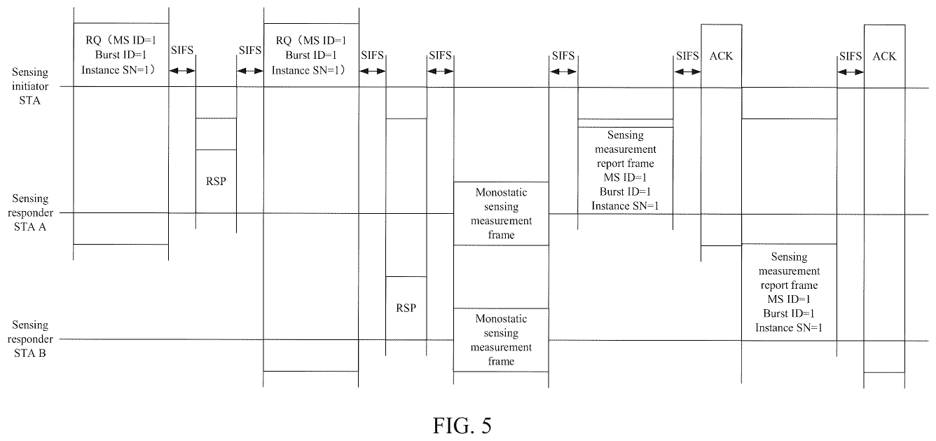

The millimeter wave coordinated monostatic sensing measurement instance may be in two modes, that is, in a sequential mode and in a parallel mode. Illustratively, FIG. 4 is a schematic diagram of a sequential mode instance of millimeter wave coordinated monostatic sensing measurement according to some embodiments of the present disclosure, and FIG. 5 is a schematic diagram of a parallel mode instance of millimeter wave coordinated monostatic sensing measurement according to some embodiments of the present disclosure.

As illustrated in FIG. 4 and FIG. 5, similarities between the sequential mode and the parallel mode lie in that: the sensing initiator needs to transmit a millimeter wave sensing request (DMG sensing request) frame to each sensing responder in the initial phase of the sensing measurement instance, and each sensing responder needs to reply a millimeter wave sensing response (DMG sensing response) frame to the sensing initiator within a short interframe space (SIFS) duration. A DMG sensing request is also referred to as an RQ, and a DMG sensing response is also referred to as an RSP.

As illustrated in FIG. 4 and FIG. 5, differences between the sequential mode and the parallel mode lie in that: each sensing responder sequentially self-transmits and self-receives a monostatic sensing measurement frame (a monostatic PPDU) to sense the environment and transmits a sensing measurement report frame (DMG sensing measurement report) to the sensing initiator within the SIFS duration in the sequential mode, and each sensing responder concurrently transmits and receives the monostatic sensing measurement frame to sense the environment and sequentially transmits DMG sensing measurement report frames (sensing measurement report frames) to the sensing initiator in the parallel mode.

It should be noted that in FIG. 4 and FIG. 5, boxes above the horizontal line corresponding to the sensing initiator or the sensing responder represent frames transmitted by the device, boxes (blank boxes) below the horizontal line represent frames received by the device, and the transmitted frames correspond to the received frames. Boxes on the horizontal line corresponding to the sensing responder represent frames self-transmitted and self-received by the sensing responder, such as the monostatic sensing measurement frame self-transmitted and self-received by the sensing responder. For example, in FIG. 4, the sensing initiator transmits the RQ (represented by the box above the horizontal line corresponding to the sensing initiator) to the sensing responder STA A, and the sensing responder STA A receives the RQ (represented by the blank box below the horizontal line corresponding to the sensing responder STA A) accordingly. For meanings of the blank boxes in the other drawings of the present disclosure, reference may be made to the above description, which are not described again herein.

A frame format of a DMG Sensing Measurement Setup element is described hereinafter.

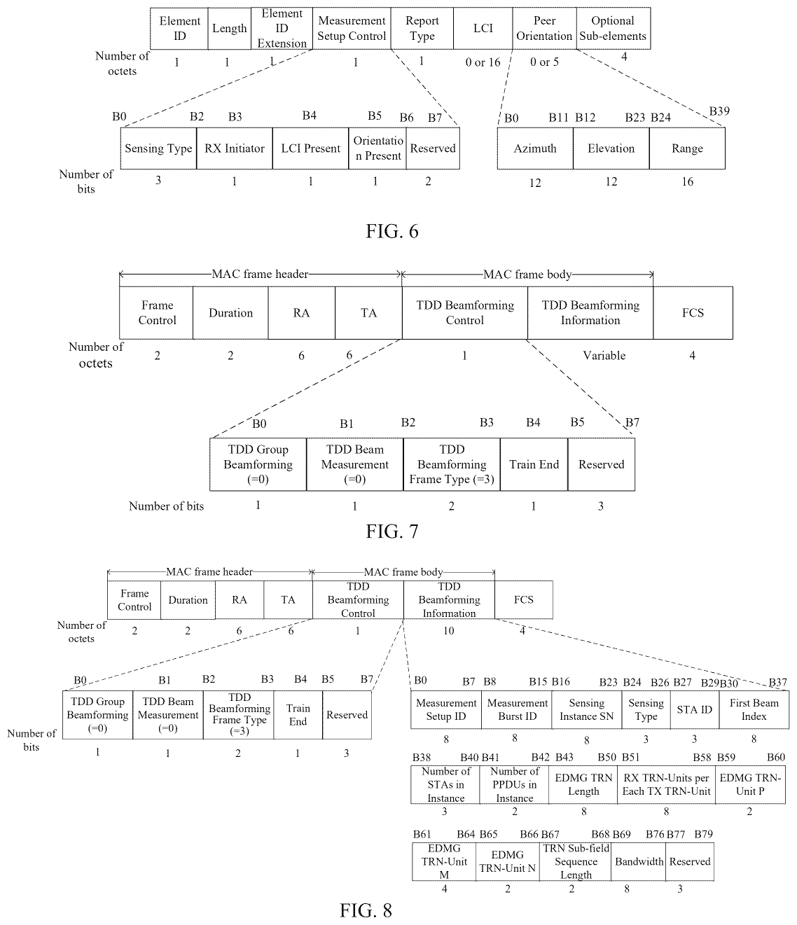

FIG. 6 is a schematic diagram of a frame format of a DMG Sensing Measurement Setup element according to some embodiments of the present disclosure. As illustrated in FIG. 6, the DMG Sensing Measurement Setup element carries information of DMG sensing measurement, and is included in a DMG sensing measurement setup request frame and a DMG sensing measurement setup response frame. The DMG Sensing Measurement Setup element includes an Element ID field, a Length field, an Element ID Extension field, a Measurement Setup Control field, a Report Type field, a Local Communication Interface (LCI) field, a Peer Orientation field, and an Optional Sub-elements field. The Measurement Setup Control field includes the following fields.

A Sensing Type field indicates a type of the DMG sensing measurement. Values and meanings thereof are listed in Table 1.

TABLE 1

| Value | Meaning |
|---|---|
| 0 | Coordinated Monostatic |
| 1 | Coordinated Bistatic |
| 2 | Bistatic |
| 3 | Multi-static |
| 4 | Reserved |

A Receive (RX) Initiator field indicates that the sensing initiator is a sensing receiver or a sensing transmitter in the bistatic sensing. A value of 1 indicates that the sensing initiator is the sensing receiver, and the value of 0 indicates that the sensing initiator is the sensing transmitter.

An LCI Present field indicates whether the LCI field is present in the DMG Sensing Measurement Setup element. A value of 1 indicates that the LCI field is present in the DMG Sensing Measurement Setup element, and the value of 0 indicates that the LCI field is not present in the DMG Sensing Measurement Setup element.

An Orientation Present field indicates whether the Peer Orientation field is present in the DMG Sensing Measurement Setup element. A value of 1 indicates that the Peer Orientation field is present in the DMG Sensing Measurement Setup element, and the value of 0 indicates that the Peer Orientation field is not present in the DMG Sensing Measurement Setup element. In addition, a Report Type field in the DMG Sensing Measurement Setup element indicates the type that the sensing initiator expects to be reported by the sensing responder. Values and meanings thereof are illustrated in Table 2.

TABLE 2

| Value | Meaning |
|---|---|
| 0 | No Report |
| 1 | Channel Status Information (CSI) |
| 2 | DMG Sensing Image Direction |
| 3 | DMG Sensing Image Range-Doppler |
| 4 | DMG Sensing Image Range-Direction |
| 5 | DMG Sensing Image Doppler- |
| | Direction |
| 6 | DMG Sensing Image Range-Doppler |
| | Direction |
| 7 | Target |
| 8-255 | Reserved |

In addition, the LCI field carries the LCI field in a location configuration information report.

A Peer Orientation field indicates a direction and a range of a peer device, and includes a Direction Angle sub-field, an Elevation sub-field, and a Range sub-field. An Optional Sub-elements field includes 0 or several sub-elements, and all sub-elements and a sequence of sub-elements are listed in Table 3.

TABLE 3

| Sub-element | | |
|---|---|---|
| ID | Sub-element name | Extendibility |
| 1 | Transmit (TX) Beam List | Yes |
| 2 | RX Beam List | Yes |
| 3 | DMG Sensing Scheduling | Yes |
| 4-255 | Reserved | No |

A Time-Division Duplexing (TDD) beamforming frame is described hereinafter.

FIG. 7 is a schematic diagram of a format of a beamforming frame according to some embodiments of the present disclosure. As illustrated in FIG. 7, the TDD Beamforming frame is a Control frame. A MAC frame body of the TDD Beamforming frame includes a TDD Beamforming Control field and a TDD Beamforming Information field. The fields in a MAC frame header of the TDD Beamforming frame have following meanings.
A Frame Control field indicates information such as the type of the MAC frame, and includes information indicating that the frame is the TDD Beamforming frame.
A Duration field indicates a length of a transmit duration of the frame.
A receiver address (RA) field indicates an MAC address of the frame receiver.
A transmitter address (TA) field indicates an MAC address of the frame transmitter.
A TDD Beamforming Frame Type field indicates a type of the TDD Beamforming frame. Values and meanings thereof are listed in Table 4.

TABLE 4

| Value | Meaning |
|---|---|
| 0 | TDD sector sweep (SSW) |
| 1 | TDD SSW feedback |
| 2 | TDD SSW ack |
| 3 | DMG sensing |

As listed in Table 4, the values of 0, 1, and 2 of the TDD Beamforming Frame Type field indicate that the TDD Beamforming frame is of a type related to the beam training. The type is not correlated with the method according to the embodiments of the present disclosure. The value of 3 indicates that the TDD Beamforming frame is of a type related to the DMG sensing. In the case that the value of the TDD Beamforming Frame Type field is 3, a TDD Group Beamforming field and a TDD Beam Measurement field jointly indicate usage of the TDD beamforming frame in the DMG sensing. Values and meanings thereof are listed in Table 5.

TABLE 5

| Value of TDD Group | Value of TDD Beam | |
|---|---|---|
| Beamforming field | Measurement field | Usage of frame |
| 0 | 0 | DMG sensing request |
| 0 | 1 | DMG sensing response |
| 1 | 0 | DMG sensing poll |
| 1 | 1 | Reserved |

As listed in Table 5, in the case that the value of the TDD Group Beamforming field is 0 and the value of the TDD Beam Measurement field is 0, the TDD beamforming frame is a DMG sensing request frame; in the case that the value of the TDD Group Beamforming field is 0 and the value of the TDD Beam Measurement field is 1, the TDD Beamforming frame is a DMG sensing response frame; and in the case that the value of the TDD Group Beamforming field is 1 and the value of the TDD Beam Measurement field is 0, the TDD Beamforming frame is a DMG sensing poll frame.

The DMG sensing request frame is described.

FIG. 8 is a schematic diagram of a format of a sensing request frame according to some embodiments of the present disclosure. As illustrated in FIG. 8, fields in the TDD Beamforming Information field in the DMG sensing request frame have the following meanings.
A Measurement Setup ID field indicates an ID of the sensing measurement setup related to the frame.
A Measurement Burst ID field indicates an ID of the sensing measurement burst related to the frame.
A Measurement Instances SN field indicates a sequential number of a sensing measurement instance in a measurement burst.
A Sensing Type field indicates a sensing type requested by the frame. Values and meanings thereof are illustrated in Table 6.

TABLE 6

| Value | Meaning |
|---|---|
| 0 | Coordinated monostatic |
| 1 | Coordinated bistatic |
| 2 | Multi-static |
| 3 | Reserved |

An STA ID field indicates a sequence of an STA participating in measurement in a sensing measurement instance.
A First Beam Index field indicates an index of a transmit beam first used in a sensing measurement instance.
A Number of STAs in Instance field indicates a number of STAs participating in measurement in a sensing measurement instance.
A Number of PPDUs in Instance field indicates a number of PPDUs in a sensing measurement instance.
An EDMG TRN Length field indicates a number of TRN-units in a PPDU.
An RX TRN-Units per Each TX TRN-Unit field indicates a number of TRN-units continuously transmitted in a same direction.
An EDMG TRN-Unit P field indicates a number of TRN sub-fields with a beam direction aligned with a peer device in a TRN-unit.
An EDMG TRN-Unit M field indicates a number of TRN sub-fields with a variable beam direction in a TRN-unit.
An EDMG TRN-Unit N field indicates a number of TRN sub-fields continuously transmitted in a same beam direction in TRN-Unit-M TRN fields.
A TRN Field Sequence Length field indicates a length of a Gray sequence used in each TRN field.
A Bandwidth field indicates a bandwidth used for transmitting the TRN field.

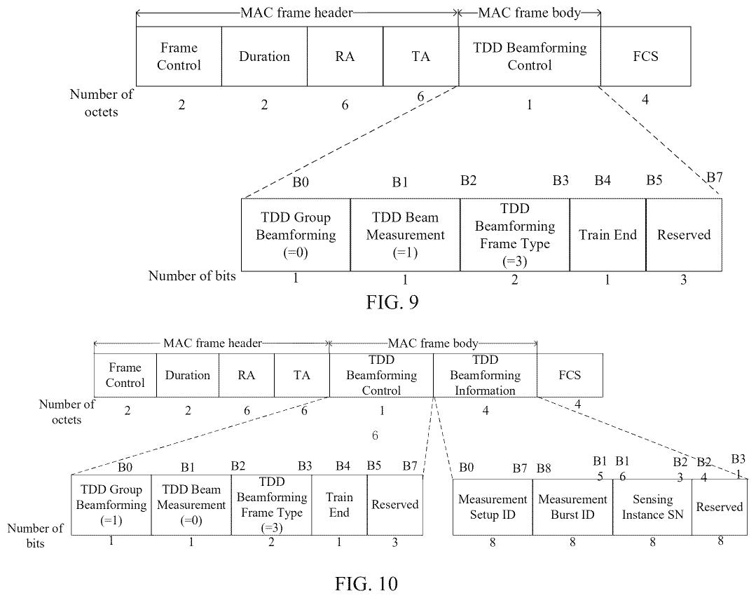

A DMG sensing response frame is described. FIG. 9 is a schematic diagram of a format of a sensing response frame according to some embodiments of the present disclosure. As illustrated in FIG. 9, a MAC frame body of the DMG sensing response frame only includes a TDD Beamforming Control field.

A sensing poll frame is described.

FIG. 10 is a schematic diagram of a format of a sensing poll frame according to some embodiments of the present disclosure. As illustrated in FIG. 10, fields in the TDD Beamforming Information field in the DMG sensing poll frame have the following meanings.
A Measurement Setup ID field indicates an ID of the sensing measurement setup related to the DMG sensing poll frame.
A Measurement Burst ID field indicates an ID of the sensing measurement burst related to the DMG sensing poll frame.
A Measurement Instances SN field indicates an ID of a sensing measurement instance related to the DMG sensing poll frame.

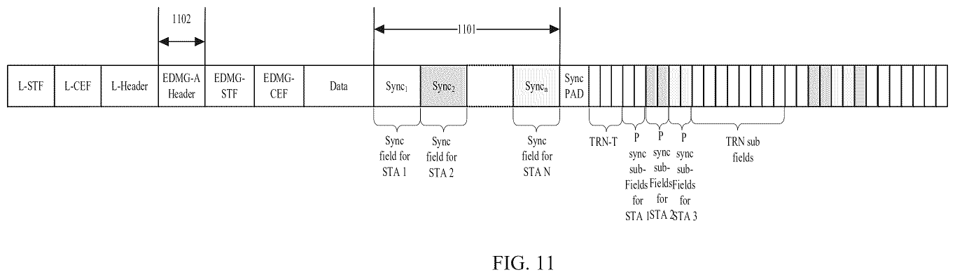

FIG. 11 is a schematic diagram of an EDMG multi-static sensing PPDU according to some embodiments of the present disclosure.

The EDMG multi-static sensing PPDU is acquired by adding a Sync field and a Sync pad (PAD) field in an EDMG beam refinement protocol PPDU in the IEEE 802.11 standard. The Sync field includes a plurality of Sync sub-fields (a Sync 1 sub-field, a Sync 2 sub-field, . . . , a Sync n sub-field), and different Sync sub-fields are directionally transmitted to different STAs participating in the multi-static sensing instance to trigger a plurality of STAs to receive TRN fields in the EDMG multi-static sensing PPDU concurrently and to achieve the DMG multi-static sensing type of one transmission and multi-receipt. The Sync PAD field is for padding, such that a total length of the Sync field and the Sync PAD field is reasonable to avoid mis-parse of the PPDU by traditional devices.

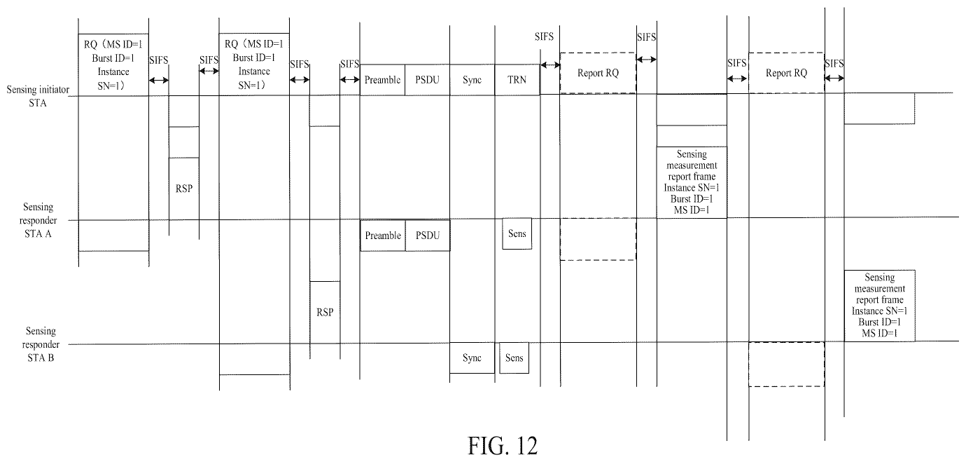

FIG. 12 is a schematic diagram of a multi-static sensing measurement instance.

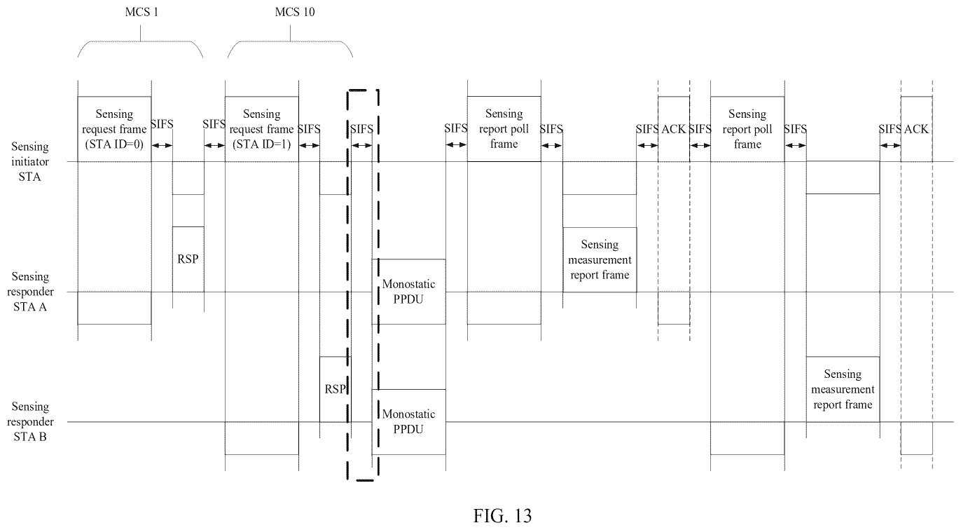

In some practices, WLAN sensing supports a plurality of sensing types. Coordinated monostatic sensing is a sensing type, and includes two modes. In parallel coordinated monostatic sensing, more than one sensing measurement device participates in the sensing, and each sensing responder senses the environment using a self-transmission monostatic PPDU and a self-received echo signal, and reports a sensing measurement report frame to a sensing initiator. A timing problem is present in reporting the sensing measurement report frame by a plurality of sensing responders. Referring to FIG. 13, FIG. 13 is a schematic diagram of a parallel coordinated monostatic sensing measurement instance in some practices.

The parallel coordinated monostatic sensing measurement instance illustrated in FIG. 13 is applicable to a sensing initiator and two sensing responders (an STA and an STA B). As required in related standards, the STA and the STA B need to self-transmit and self-receive the monostatic sensing measurement frame (the monostatic PPDU) within the SIFS upon transmission of the sensing response frame (RSP) by the STA B. However, the MCS used in transmitting the DMG sensing request frame (RQ) and the RSP between the sensing initiator and the STA A may be different from the MCS used in transmitting the DMG sensing RQ and the RSP between the sensing initiator and the STA B, such that the interaction time between the sensing initiator and the STA A is different from the interaction time between the sensing initiator and the STA B (in the case that the sensing initiator and the STA A interactively use the MCS1, and the sensing initiator and the STA B interactively use the MCS10, the timing error between them is about 0.91 μs. In the case that a maximum number of participated STAs is 8, the timing error is 6.37 μs, which is too large to be ignored), and the STA A cannot know the MCS used by the STA B. In this case, the STA A cannot calculate the time at which the STA B transmits the RSP, and thus cannot accurately transmit the monostatic PPDU within the SIFS. In addition, the STA A may not receive the RSP transmitted by the STA B to the sensing initiator. As the DMG device generally uses a narrow beam to direct to the peer device to transmit the signal, the STA A may not receive the signal of the RSP in the case that the STA A and the STA B are not in a nearby location.

The above timing process probably causes that the monostatic PPDU transmitted by different STAs may not be greatly aligned in the time, and may also cause additional interference to reduce the accuracy of the sensing result.

Accordingly, the present disclosure provides the following technical solutions.

A first technical solution is described in detail hereinafter.

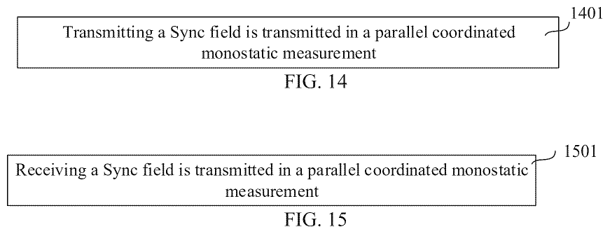

FIG. 14 is a flowchart of a method for sensing measurement according to some embodiments of the present disclosure. The embodiments are illustrated using an example where the method is applicable to a sensing initiator. The method includes the following process.

In S1401, a Sync field is transmitted in a parallel coordinated monostatic measurement.

In some embodiments, the Sync field is used to trigger a sensing responder to transmit a monostatic PPDU. In some embodiments, the Sync field refers to a Synchronous field. In some embodiments, the Sync field includes at least one Sync subfield. The at least one Sync subfield is directionally transmitted to the sensing responder corresponding to the Sync subfield. In some embodiments, the at least one Sync subfield includes a Sync 1 field, a Sync 2 field, a Sync 3 field, and the like. Illustratively, the Sync 1 field is transmitted to a corresponding sensing responder STA 1, the Sync 2 field is transmitted to a corresponding sensing responder STA 2, and the Sync 3 field is transmitted to a corresponding sensing responder STA 3.

In some embodiments, the Sync field is used to trigger at least two sensing responders to concurrently transmit the monostatic PPDU. Illustratively, the Sync field is used to trigger the sensing responder STA 1 and the sensing responder STA 2 to concurrently transmit the monostatic PPDU. In some embodiments, the Sync field is used to trigger the sensing responder to transmit the monostatic PPDU after a first space. In some embodiments, the first space is an SIFS, and the Sync field is used to trigger the sensing responder to transmit the monostatic PPDU after an SIFS.

In some embodiments, the Sync field is carried in a first frame. In some embodiments, the first frame is an EDMG multi-static sensing PPDU. In conjunction with FIG. 11, FIG. 11 shows a schematic diagram of an EDMG multi-static sensing PPDU. The EDMG multi-static sensing PPDU includes a Sync field 1101, and the Sync field 1101 includes at least one Sync subfield (a Sync 1 field, a Sync 2 field, . . . , a Sync n field).

In some embodiments, the first frame includes a first type field. A value of the first type field indicates that the first frame is used for the parallel coordinated monostatic measurement. In some embodiments, the first frame is an EDMG multi-static sensing PPDU, and the first type field is a Sensing Type field in an EDMG-Header-A field. In conjunction with FIG. 11, FIG. 11 shows an EDMG-Header-A field 1102 in the EDMG multi-static sensing PPDU.

In some embodiments, the first frame includes a first number field. A value of the first number field indicates a number of Sync subfields in the first frame. In some embodiments, the first frame is an EDMG multi-static sensing PPDU, and the first number field is a Multi-static Sensing Number of Stations (NSTA) field in an EDMG-Header-A field. In conjunction with FIG. 11, FIG. 11 shows an EDMG-Header-A field 1102 in the EDMG multi-static sensing PPDU.

In some embodiments, the first frame includes a first length field. A value of the first length field indicates a number of TRN fields in the first frame. In some embodiments, the first frame is an EDMG multi-static sensing PPDU, and the first length field is an EDMG TRN Length field in an EDMG-Header-A field. In conjunction with FIG. 11, FIG. 11 shows an EDMG-Header-A field 1102 in the EDMG multi-static sensing PPDU. In some embodiments, in the case that the first frame is used for the parallel coordinated monostatic measurement, the value of the EDMG TRN Length field is specified as 0 by the protocol.

In some embodiments, the method illustrated in FIG. 14 further includes carrying a first parameter in a transmit vector transmitted from an MAC layer to a physical layer (PHY), wherein a value of the first parameter indicates that the first frame is used for the parallel coordinated monostatic measurement. In some embodiments, the first parameter is also referred to as a PARALLEL_COORDINATED_MONOSTATIC parameter. In some embodiments, in the case that the value of the first parameter is a target value, the first frame is used for the parallel coordinated monostatic measurement. In some embodiments, in the case that the value of the first parameter is 1, the first frame is used for the parallel coordinated monostatic sensing measurement. In some embodiments, in the case that the value of the first parameter is 0, the first frame is used for the multi-static sensing measurement.

In some embodiments, the following rows are added in TXVECTOR and RXVECTOR parameters in Table 28-1 in the standard.

TABLE 7
TXVECTOR and RXVECTOR parameters

| Parameters | Condition | Value | TXVECTOR | RXVECTOR |
|---|---|---|---|---|
| EDMG_MS_SENSING Parameters | FORMAT is DMG, | Set to 1 indicates | Y | N |
| | DMG_MODULATION is | that the PPDU is | | |
| | DMG_SC_MODE, | an EDMG | | |
| | NUM_USERS is 1, | Multistatic | | |
| | NUM_STS is 1 | sensing PPDU. | | |
| | | Set to 0 otherwise. | | |
| | Otherwise | Not present | N | N |
| DMG_MS_SENSING_NSTA Parameters | FORMAT is EDMG, | Set to the number | Y | N |
| | EDMG_MS_SENSING | of Sync subfields | | |
| | is 1. | in this EDMG | | |
| | | multistatic sensing | | |
| | | PPDU. | | |
| | Otherwise | Not present | N | N |
| PARALLEL_COORDINATED_MONOSTATIC | FORMAT is EDMG, | Indicate the | Y | N |
| Parameters | EDMG_MS_SENSING | EDMG | | |
| | is 1. | Multistatic | | |
| | | sensing PPDU is | | |
| | | used for | | |
| | | Multistatic or | | |
| | | Parallel | | |
| | | Coordinated | | |
| | | Monostatic | | |
| | | Sensing type. | | |
| | | Set to 0 to | | |
| | | indicate that the | | |
| | | EDMG | | |
| | | Multistatic | | |
| | | sensing PPDU is | | |
| | | used for | | |
| | | Multistatic | | |
| | | Sensing type. | | |
| | | Set to 1 to | | |
| | | indicate that the | | |
| | | EDMG | | |
| | | Multistatic | | |
| | | sensing PPDU is | | |
| | | used for Parallel | | |
| | | Coordinated | | |
| | | Monostatic | | |
| | | Sensing type. | | |
| | Otherwise | Not present | N | N |

In summary, the sensing initiator transmits the Sync field to trigger the sensing responder to transmit the monostatic PPDU, such that the timing problem in the parallel coordinated monostatic sensing measurement is solved.

FIG. 15 is a flowchart of a method for sensing measurement according to some embodiments of the present disclosure. The embodiments are illustrated using an example where the method is applicable to a sensing responder. The method includes the following process.

In S1502, a Sync field is received in a parallel coordinated monostatic measurement.

In some embodiments, the Sync field is used to trigger a sensing responder to transmit a monostatic PPDU. In some embodiments, the Sync field is a Synchronous field. In some embodiments, the Sync field includes at least one Sync subfield.

In some embodiments, the Sync subfield corresponding to the sensing responder is received in the parallel coordinated monostatic measurement. In some embodiments, the at least one Sync subfield includes a Sync 1 field, a Sync 2 field, a Sync 3 field, and the like. Illustratively, the sensing responder STA 1 receives the Sync 1 field, the sensing responder STA 2 receives the Sync 2 field, and the sensing responder STA 3 receives the Sync 3 field.

In some embodiments, the Sync field is used to trigger at least two sensing responders to concurrently transmit the monostatic PPDU. Illustratively, the Sync field is used to trigger the sensing responder STA 1 and the sensing responder STA 2 to concurrently transmit the monostatic PPDU. Illustratively, the sensing responder STA 1 receives the Sync 1 field, the sensing responder STA 2 receives the Sync 2 field, and the sensing responder STA 3 receives the Sync 3 field.

In some embodiments, the Sync field is used to trigger the sensing responder to transmit the monostatic PPDU after a first space. In some embodiments, the first space is an SIFS. The Sync 1 field triggers the sensing responder STA 1 to transmits the monostatic PPDU after an SIFS, and the Sync 2 field triggers the sensing responder STA 2 to transmits the monostatic PPDU after an SIFS.

In some embodiments, the Sync field is carried in a first frame. In some embodiments, the first frame is an EDMG multi-static sensing PPDU. In conjunction with FIG. 11, FIG. 11 shows a schematic diagram of an EDMG multi-static sensing PPDU. The EDMG multi-static sensing PPDU includes a Sync field 1101, and the Sync field 1101 includes at least one Sync subfield (a Sync 1 field, a Sync 2 field, . . . , a Sync n field).

In some embodiments, the first frame includes a first type field. A value of the first type field indicates that the first frame is used for the parallel coordinated monostatic measurement. In some embodiments, the first frame is an EDMG multi-static sensing PPDU, and the first type field is a Sensing Type field in an EDMG-Header-A field. In conjunction with FIG. 11, FIG. 11 shows an EDMG-Header-A field 1102 in the EDMG multi-static sensing PPDU.

In some embodiments, the first frame includes a first number field. A value of the first number field indicates a number of Sync subfields in the first frame. In some embodiments, the first frame is an EDMG multi-static sensing PPDU, and the first number field is a Multi-static Sensing Number of Stations (NSTA) field in an EDMG-Header-A field. In conjunction with FIG. 11, FIG. 11 shows an EDMG-Header-A field 1102 in the EDMG multi-static sensing PPDU.

In some embodiments, the first frame includes a first length field. A value of the first length field indicates a number of TRN fields in the first frame. In some embodiments, the first frame is an EDMG multi-static sensing PPDU, and the first length field is an EDMG TRN Length field in an EDMG-Header-A field. In conjunction with FIG. 11, FIG. 11 shows an EDMG-Header-A field 1102 in the EDMG multi-static sensing PPDU. In some embodiments, in the case that the first frame is used for the parallel coordinated monostatic measurement, the value of the EDMG TRN Length field is specified as 0 by the protocol.

In summary, the sensing responder receives the Sync field to trigger the sensing responder to transmit the monostatic PPDU, such that the timing problem in the parallel coordinated monostatic sensing measurement is solved.

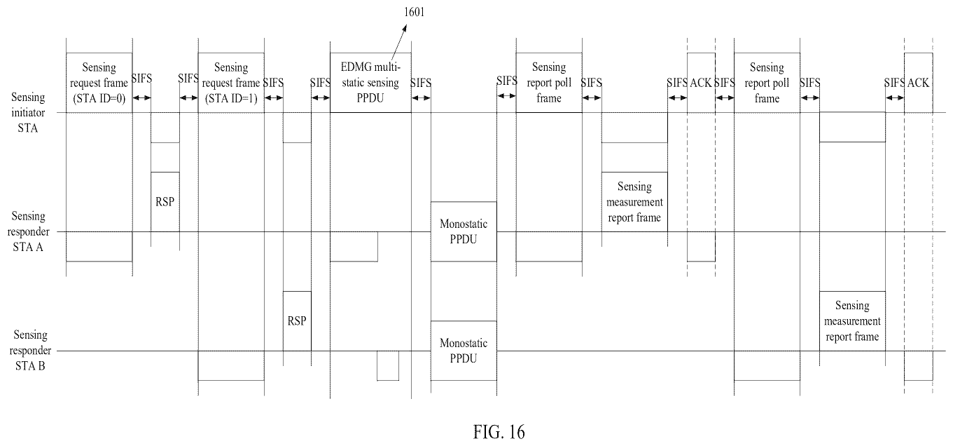

The parallel coordinated monostatic sensing measurement instance according to the embodiments of the present disclosure is described using an example where two sensing responders are the STA 1 and the STA 2. FIG. 16 is a schematic diagram of a method for sensing measurement according to some embodiments of the present disclosure. the method includes the following processes.

(1) A sensing initiator transmits a sensing request frame (DMG sensing request) to a sensing responder STA A. In some embodiments, in the sensing request frame, “Number of STAs in INSTANCE” is set to 2, “STA ID” is set to 0, “Sensing Type” is set to 1.

(2) The STA A replays a sensing response frame (DMG sensing response) to the sensing initiator after no more than an SIFS.

(3) The sensing initiator transmits a sensing request frame (DMG sensing request) to a sensing responder STA B after no more than an SIFS. In some embodiments, in the sensing request frame, “Number of STAs in INSTANCE” is set to 2, “STA ID” is set to 1, “Sensing Type” is set to 1.

(4) The STA B replays a sensing response frame (DMG sensing response) to the sensing initiator after no more than an SIFS.

(5) The sensing initiator transmits an EDMG multi-static sensing PPDU to the sensing responder STA A and the sensing responder STA B after no more than an SIFS.

In some embodiments, in conjunction with FIG. 16, the EDMG multi-static sensing PPDU 1601 includes the Sync field. In some embodiments, the Sync field includes the Sync 1 field and the Sync 2 field. The Sync 1 field is directionally transmitted to the sensing responder STA A, and the Sync 2 field is directionally transmitted to the sensing responder STA B. In some embodiments, the Sync 1 field is used to trigger the sensing responder STA A to transmit the monostatic PPDU, and the Sync 2 field is used to trigger the sensing responder STA B to transmit the monostatic PPDU. In some embodiments, the Sync field is used to trigger the sensing responder STA A and the sensing responder STA B to concurrently transmit the monostatic PPDU. In some embodiments, the Sync 1 field is used to trigger the sensing responder STA A to transmit the monostatic PPDU after an SIFS subsequent to the receipt end time of the EDMG multi-static sensing PPDU.

In some embodiments, a value of the “Multi-static Sensing” field in the EDMG-Header-A field in the EDMG multi-static sensing PPDU indicates that the PPDU is the EDMG multi-static sensing PPDU. In some embodiments, the value of the “Multi-static Sensing” is 1 to indicate that the PPDU is the EDMG multi-static sensing PPDU.

In some embodiments, a value of the Sensing Type field “Parallel Coordinated Monostatic” in the EDMG-Header-A field in the EDMG multi-static sensing PPDU indicates that the PPDU is the EDMG multi-static sensing PPDU. In some embodiments, the value of the “Parallel Coordinated Monostatic” is 1 to indicate that the PPDU is used for the parallel coordinated monostatic sensing measurement.

In some embodiments, a value of the “Multistatic Sensing NSTA” field in the EDMG-Header-A field in the EDMG multi-static sensing PPDU indicates a number of Sync subfield in the Sync field in the EDMG multi-static sensing PPDU.

In some embodiments, a value of the “EDMG TRN Length” field in the EDMG-Header-A field in the EDMG multi-static sensing PPDU indicates a number of TRN fields in the EDMG multi-static sensing PPDU. In some embodiments, the value of the “EDMG TRN Length” field is specified to 0 in the parallel coordinated monostatic sensing measurement in the protocol.

Illustratively, the last row of the EDMG-MCS field definition when the Number of SS field is 0 in Table 28-13 in the standard is replaced by the following rows.

TABLE 8
EDMG-MCS field definition when the Number of SS field is 0

| | Number | Start | |
|---|---|---|---|
| Subfield | of bits | bit | Description |
| Multistatic | 1 | 9 | Corresponds to TXVECTOR parameter EDMG_MS_SENSING. |
| Sensing | | | Set to 1 to indicate that the PPDU is an EDMG Multistatic sensing |
| | | | PPDU. Set to 0 otherwise. |
| Multistatic | 3 | 10 | Corresponds to TXVECTOR parameter MG_MS_SENSING_NSTA. |
| Sensing NSTA | | | Set to the number of Sync subfields in this EDMG Multistatic |
| | | | sensing PPDU. |
| Parallel | 1 | 13 | Corresponds to TXVECTOR parameter PARALLEL_COORDINATED_MONOSTATIC. |
| Coordinated | | | Set to 0 to indicate that the EDMG Multistatic sensing PPDU is used for Multistatic |
| Monostatic | | | Sensing type. Set to 1 to indicate that the EDMG Multistatic sensing PPDU is |
| | | | used for Parallel Coordinated Monostatic Sensing type. The number of Sync |
| | | | subfields in this EDMG Multistatic sensing PPDU is indicated by Multistatic |
| | | | Sensing NSTA field. If the value of this field is set to 0, the value |
| | | | of the EDMG TRN Length is set to 0. |
| Reserved | 7 | 14 | |

(6) The sensing responder STA A and the sensing responder STA B respectively self-transmit and self-receive a monostatic PPDU after no more than an SIFS to sense the environment.

(7) The sensing initiator transmits a sensing report poll frame (DMG Sensing Report Poll) to the sensing responder STA A after no more than an SIFS to trigger the sensing responder STA A to report a sensing measurement result.

(8) The sensing responder STA A transmits a sensing measurement report frame (DMG Sensing Measurement Report) to the sensing initiator after no more than an SIFS.

(9) The sensing initiator transmits an ACK frame to the sensing responder STA A after no more than an SIFS.

In some embodiments, (9) is an alternative process, and the sensing initiator does not need the ACK frame in the parallel coordinated monostatic sensing measurement.

(10) The sensing initiator transmits a sensing report poll frame (DMG Sensing Report Poll) to the sensing responder STA B after no more than an SIFS to trigger the sensing responder STA B to report a sensing measurement result.

(11) The sensing responder STA B transmits a sensing measurement report frame (DMG Sensing Measurement Report) to the sensing initiator after no more than an SIFS.

(12) The sensing initiator transmits an ACK frame to the sensing responder STA B after no more than an SIFS.

In some embodiments, (12) is an alternative process, and the sensing initiator does not need the ACK frame in the parallel coordinated monostatic sensing measurement.

In summary, the sensing initiator transmits the EDMG multi-static sensing PPDU, and the sensing responder receives the Sync field, such that at least two sensing responders aligns the time for transmitting the monostatic PPDU.

It should be noted that the location, the field length, and the field value of the above Sync field, the first type field, the first number field, and the first length field all are exemplary. It should be understood that any field that plays a similar role, regardless of whether the field location, the field length, and the field value are consistent with the above examples, shall fall within the scope of protection of the present disclosure.

A second technical solution is described in detail.

In the above description, the MCS used in transmitting the sensing request frame (DMG sensing request) and the sensing response frame (DMG sensing response) between the sensing initiator and the sensing responder STA A may be different from the MCS used in transmitting the sensing request frame and the sensing response frame between the sensing initiator and the sensing responder STA B, and thus the interaction time between the sensing initiator and the STA A is different from the interaction time between the sensing initiator and the STA B. Thus, in the second technical solution, the protocol specifies that the sensing initiator and the sensing responder use the same MCS.

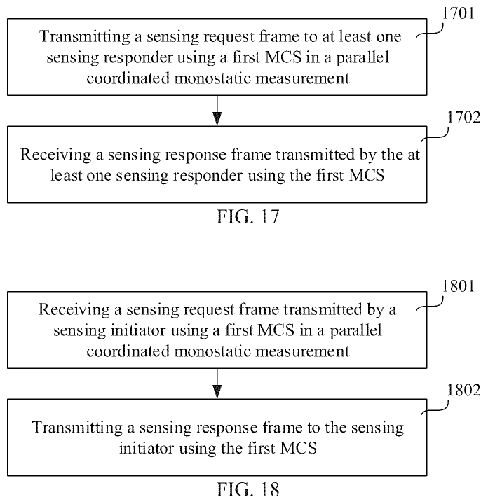

FIG. 17 is a flowchart of a method for sensing measurement according to some embodiments of the present disclosure. The embodiments are illustrated using an example where the method is applicable to a sensing initiator. The method includes the following processes.

In S1701, a sensing request frame is transmitted to at least one sensing responder using a first MCS in a parallel coordinated monostatic measurement.

The first MCS is an MCS specified in the protocol.

In some embodiments, the protocol specifies that the first MCS is any of an MCS 0 to an MCS 5, and an MCS 7 to an MCS 10. Illustratively, Table 9 lists the MCS 0 in the protocol.

TABLE 9

| MCS index | Modulation | Code rate | Data rate |
|---|---|---|---|
| 0 | DBPSK | 1/2^{a} | 27.5 Mb/s^{a} |

Table 10 lists a plurality of MCSs defined for the EDMGPHY in the protocol, and different MCSs have different data rates. NcB represents a number of continuous band.

TABLE 10

| EDMG- | | | | | Data rate per spatial stream (Mb/s) | | |
|---|---|---|---|---|---|---|---|
| MCS | | | | Code | Normal Guard | | |
| index | Modulation | NCBPS | Repetition | rate | Interval (GI) | Short GI | Long GI |
| 1 | π/2 -BPSK | 1 | 2 | 1/2 | N_{CB} × 385.00 | N_{CB} × 412.50 | N_{CB} × 330.00 |
| 2 | π/2 -BPSK | 1 | 1 | 1/2 | N_{CB} × 777.00 | N_{CB} × 825.00 | N_{CB} × 660.00 |
| 3 | π/2 -BPSK | 1 | 1 | 5/8 | N_{CB} × 962.50 | N_{CB} × 1031.25 | N_{CB} × 825.00 |
| 4 | π/2 -BPSK | 1 | 1 | 3/4 | N_{CB} × 1155.00 | N_{CB} × 1237.50 | N_{CB} × 990.00 |
| 5 | π/2 -BPSK | 1 | 1 | 13/16 | N_{CB} × 1251.25 | N_{CB} × 1340.63 | N_{CB} × 1072.50 |
| 6 | π/2 -BPSK | 1 | 1 | 7/8 | N_{CB} × 1347.50 | N_{CB} × 1443.75 | N_{CB} × 1155.00 |
| 7 | π/2 -BPSK | 2 | 1 | 1/2 | N_{CB} × 1540.00 | N_{CB} × 1650.00 | N_{CB} × 1320.00 |
| 8 | π/2 -BPSK | 2 | 1 | 5/8 | N_{CB} × 1925.00 | N_{CB} × 2062.50 | N_{CB} × 1650.00 |
| 9 | π/2 -BPSK | 2 | 1 | 3/4 | N_{CB} × 2310.00 | N_{CB} × 2475.00 | N_{CB} × 1980.00 |
| 10 | π/2 -BPSK | 2 | 1 | 13/16 | N_{CB} × 2502.00 | N_{CB} × 2681.25 | N_{CB} × 2145.00 |
| 11 | π/2 -BPSK | 2 | 1 | 7/8 | N_{CB} × 2695.00 | N_{CB} × 2887.50 | N_{CB} × 2310.00 |
| 12 | π/2-16-QAM | 4 | 1 | 1/2 | N_{CB} × 3080.00 | N_{CB} × 3300.00 | N_{CB} × 2640.00 |
| 13 | π/2-16-QAM | 4 | 1 | 5/8 | N_{CB} × 3850.00 | N_{CB} × 4125.00 | N_{CB} × 3300.00 |
| 14 | π/2-16-QAM | 4 | 1 | 3/4 | N_{CB} × 4620.00 | N_{CB} × 4950.00 | N_{CB} × 3960.00 |
| 15 | π/2-16-QAM | 4 | 1 | 13/16 | N_{CB} × 5005.00 | N_{CB} × 5362.50 | N_{CB} × 4290.00 |
| 16 | π/2-16-QAM | 4 | 1 | 7/8 | N_{CB} × 5390.00 | N_{CB} × 5775.00 | N_{CB} × 4620.00 |
| 17 | π/2-64-QAM | 6 | 1 | 1/2 | N_{CB} × 4620.00 | N_{CB} × 4950.00 | N_{CB} × 3960.00 |
| 18 | π/2-64-QAM | 6 | 1 | 5/8 | N_{CB} × 5775.00 | N_{CB} × 6187.50 | N_{CB} × 4950.00 |
| 19 | π/2-64-QAM | 6 | 1 | 3/4 | N_{CB} × 6390.00 | N_{CB} × 7425.00 | N_{CB} × 5940.00 |
| 20 | π/2-64-QAM | 6 | 1 | 13/16 | N_{CB} × 7507.50 | N_{CB} × 8043.75 | N_{CB} × 6435.00 |
| 21 | π/2-64-QAM | 6 | 1 | 7/8 | N_{CB} × 8085.00 | N_{CB} × 8662.50 | N_{CB} × 6930.00 |

In some embodiments, at least two sensing responders are present in the parallel coordinated monostatic measurement. In some embodiments, an i^{th} sensing request frame is transmitted at an i^{th} time after a transmission end time of an (i−1)^{th} sensing request frame in response to a frame transmission error. A duration between the i^{th} time and the transmission end time is a duration specified in the protocol, and the (i−1)^{th} sensing request frame and the i^{th} sensing request frame are transmitted using the first MCS. i is a positive integer greater than 1.

In some embodiments, the duration between the i^{th} time and the transmission end time includes two first intervals and a reserved transmission duration of the sensing response frame. In some embodiments, the first space is the SIFS.

In some embodiments, the frame transmission error is caused due to a failure to receive the (i−1)^{th} sensing request frame by an (i−1)^{th} sensing responder. In some embodiments, the frame transmission error is caused due to a failure to receive an (i−1)^{th} sensing response frame from an (i−1)^{th} sensing responder.

In some embodiments, the protocol specifies that in the case that the sensing initiator does not receive the sensing response frame (DMG Sensing Response) within the SIFS after transmission of the sensing request frame (DMG Sensing Request) to a last sensing responder (Responder STA), the sensing initiator needs to transmit a next sensing request frame (DMG Sensing Request) to a next sensing responder (Responder STA) within (2×SIFS+TXTIMEDMG Sensing Response) time after end of the above sensing request frame (DMG Sensing Request).

In some embodiments, in the case that the sensing responder is an EDMG STA, an EDMG PPDU carrying the sensing request frame and the sensing response frame meets one of the following conditions or any combinations thereof:
the EDMG PPDU is a non-EDMG single carrier (SC) mode PPDU or a non-EDMG control mode PPDU;
the EDMG PPDU occupies a contiguous 2.16 GHz channel; and
the EDMG PPDU uses a normal guard interval.

In some embodiments, the protocol specifies that in the case that the sensing responder STA is an EDMG STA, the EDMG PPDU is the non-EDMG SC mode PPDU or a non-EDMG control mode PPDU, the EDMG PPDU occupies the contiguous 2.16 GHz channel, and the EDMG PPDU uses the normal guard interval.

In S1702, a sensing response frame transmitted by the at least one sensing responder using the first MCS is received.

The first MCS is an MCS specified in a protocol.

In some embodiments, the protocol specifies that the first MCS is any of an MCS 0 to an MCS 5, and an MCS 7 to an MCS 10.

In summary, the sensing initiator is specified to use the first MCS to transmit the sensing request frame and receive the sensing response frame transmitted using the first MCS, and the first MCS is an MCS is specified in the protocol, such that the problem that the monostatic PPDUs transmitted by different sensing responders in the parallel coordinated monostatic sensing measurement cannot be aligned in the time is solved.

FIG. 18 is a flowchart of a method for sensing measurement according to some embodiments of the present disclosure. The embodiments are illustrated using an example where the method is applicable to a sensing responder. The method includes the following processes.

In S1801, a sensing request frame transmitted by a sensing initiator using a first MCS is received in a parallel coordinated monostatic measurement.

The first MCS is an MCS specified in the protocol.

In some embodiments, the protocol specifies that the first MCS is any of an MCS 0 to an MCS 5, and an MCS 7 to an MCS 10.

In some embodiments, in the case that the sensing responder is an EDMG STA, an EDMG PPDU carrying the sensing request frame and the sensing response frame meets one of the following conditions or any combinations thereof:
the EDMG PPDU is a non-EDMG single carrier (SC) mode PPDU or a non-EDMG control mode PPDU;
the EDMG PPDU occupies a contiguous 2.16 GHz channel; and
the EDMG PPDU uses a normal guard interval.

In some embodiments, the protocol specifies that in the case that the sensing responder STA is an EDMG STA, the EDMG PPDU is the non-EDMG SC mode PPDU or a non-EDMG control mode PPDU, the EDMG PPDU occupies the contiguous 2.16 GHz channel, and the EDMG PPDU uses the normal guard interval.

In S1802, a sensing response frame is transmitted to the sensing initiator using the first MCS.

The first MCS is an MCS specified in a protocol.

In summary, the sensing initiator is specified to use the first MCS to transmit the sensing request frame and receive the sensing response frame transmitted using the first MCS, and the first MCS is an MCS is specified in the protocol, such that the problem that the monostatic PPDUs transmitted by different sensing responders in the parallel coordinated monostatic sensing measurement cannot be aligned in the time is solved.

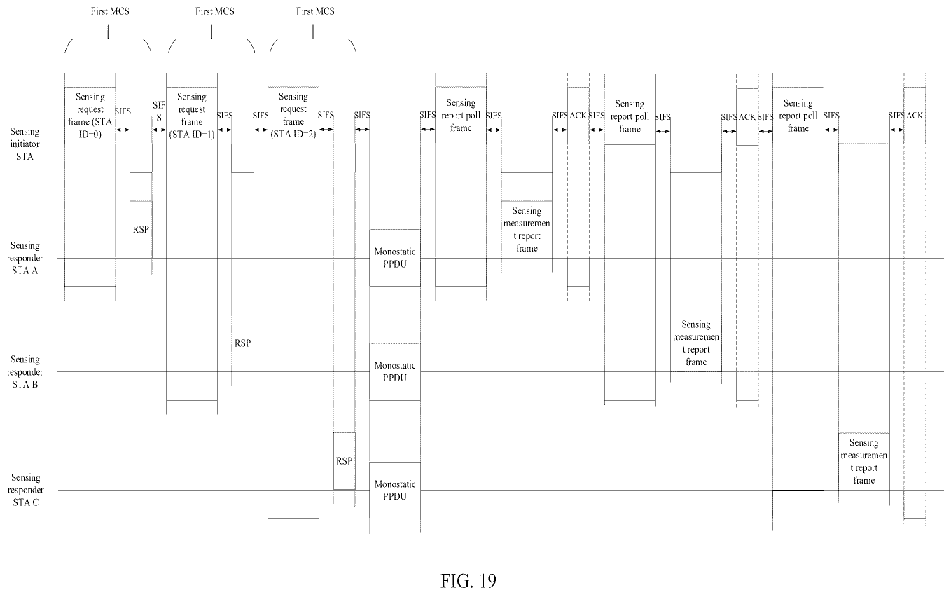

In the case that the frame transmission error does not occur, FIG. 19 is a schematic diagram of a parallel coordinated monostatic measurement in the second technical solution. FIG. 19 shows three sensing responders.

In conjunction with FIG. 19, the sensing initiator transmits the sensing request frame (DMG Sensing Request) to the sensing responder STA1, the sensing responder STA2, and the sensing responder STA3 using the first MCS; and the sensing responder STA1, the sensing responder STA2, and the sensing responder STA3 transmit the sensing response frame (DMG Sensing Response) to the sensing initiator using the first MCS.

In the parallel coordinated monostatic measurement illustrated in FIG. 19, the sensing responder STA1, the sensing responder STA2, and the sensing responder STA3 transmit the monostatic PPDU concurrently.

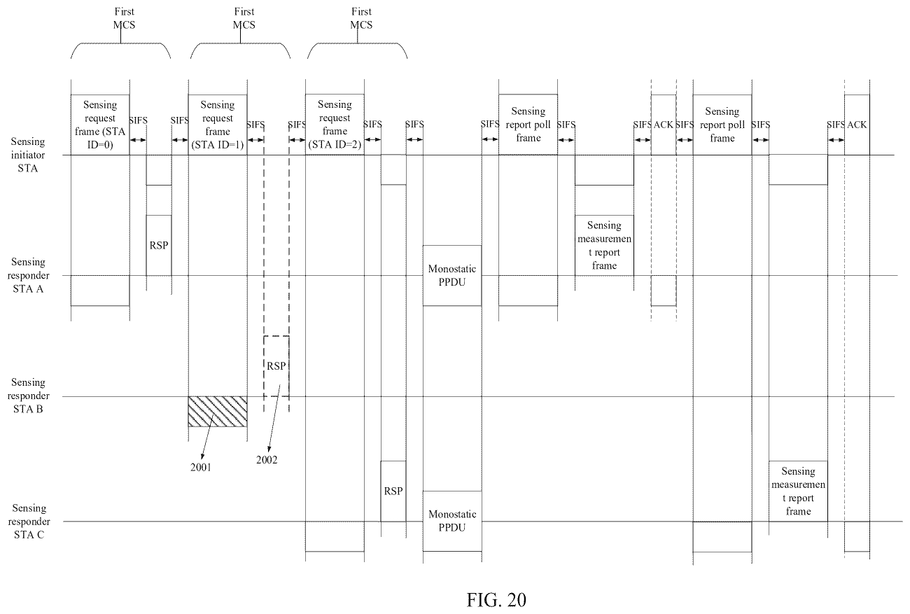

In the case that the frame transmission error occurs, the frame transmission error may be caused due to a failure to receive the (i−1)^{th} sensing request frame by the (i−1)^{th} sensing responder. FIG. 20 is a schematic diagram of a parallel coordinated monostatic measurement in the second technical solution. FIG. 20 shows three sensing responders.

In conjunction with FIG. 20, the sensing initiator transmits the sensing request frame to the sensing responder STA A, the sensing responder STA B, and the sensing responder STA C using the first MCS. However, the sensing responder STA B does not receive the sensing request frame (the gray box 2001 in FIG. 20 indicates that the sensing responder STA B failed to receive the sensing request frame) as the path for transmitting the sensing request frame from the sensing initiator to the STA B is blocked or other reasons, and then the sensing responder STA B does not reply a sensing response from to the sensing initiator after the SIFS (the blank box 2002 in FIG. 20 indicates that the sensing responder STA B des not reply the sensing response frame).

According to the provisions of the relevant protocol, the sensing initiator is capable of transmitting the sensing request frame to the next sensing responder STA C in advance, and the timing problem is still present as the interaction time between the sensing initiator and the sensing responder STA B is different from the interaction time between the sensing initiator and another sensing responder STA.

Thus, the present disclosure further provides content specified in the protocol. In the case that the sensing initiator does not receive the sensing response frame within a first duration (for example, a Short Interframe Space (SIFS) or a point coordination function (PCF) interframe space (PIFS)) after transmission of the sensing request frame to the sensing responder STA B, the sensing initiator starts to transmit a next sensing request frame to the sensing responder STA C within a second duration (such as, (2×SIFS+TXTIMEDMG Sensing Response) time) after transmission end of the sensing request frame, such that the interaction time between the sensing initiator and the sensing responder STA A, the interaction time between the sensing initiator and the sensing responder STA B, and the interaction time between the sensing initiator and another sensing responder STA are the same. On this basis, the timing problem is solved, and the procedure of the parallel coordinated monostatic sensing instance operates normally.

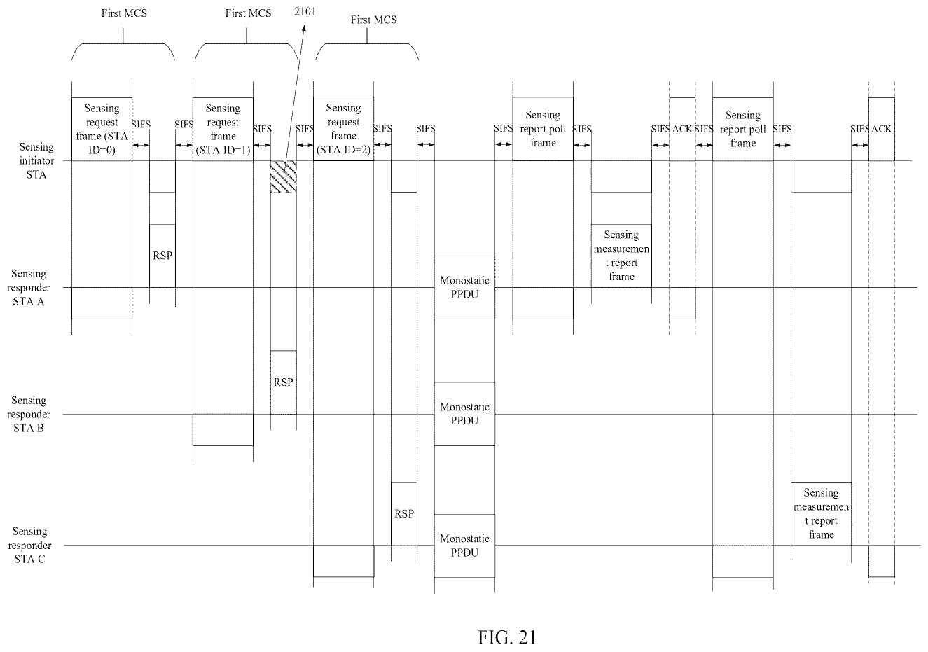

In the case that the frame transmission error occurs, the frame transmission error may be caused due to a failure to receive an (i−1)^{th} sensing response frame from an (i−1)^{th} sensing responder. FIG. 21 is a schematic diagram of a parallel coordinated monostatic measurement in the second technical solution. FIG. 21 shows three sensing responders.

In conjunction with FIG. 21, the sensing initiator transmits the sensing request frame to the sensing responder STA A, the sensing responder STA B, and the sensing responder STA C using the first MCS. However, the sensing responder receives the sensing request frame, and as the path for transmitting the sensing response frame to the sensing initiator is blocked or other reasons, the sensing initiator does not receive the sensing response from. The grey box 2101 in FIG. 21 indicates that the sensing initiator des not receive the sensing response frame.

According to the provisions of the relevant protocol, the sensing initiator may transmit the sensing request frame to the next sensing responder STA C in advance, and the timing problem is still present as the interaction time between the sensing initiator and the sensing responder STA B is different from the interaction time between the sensing initiator and another sensing responder STA.

Thus, the present disclosure further provides content specified in the protocol. In the case that the sensing initiator does not receive the sensing response frame within a first duration (for example, a Short Interframe Space (SIFS) or a point coordination function (PCF) interframe space (PIFS)) after transmission of the sensing request frame to the sensing responder STA B, the sensing initiator starts to transmit a next sensing request frame to the sensing responder STA C within a second duration (such as, (2×SIFS+TXTIMEDMG Sensing Response) time) after transmission end of the sensing request frame, such that the interaction time between the sensing initiator and the sensing responder STA A, the interaction time between the sensing initiator and the sensing responder STA B, and the interaction time between the sensing initiator and another sensing responder STA are the same. On this basis, the timing problem is solved, and the procedure of the parallel coordinated monostatic sensing instance operates normally.

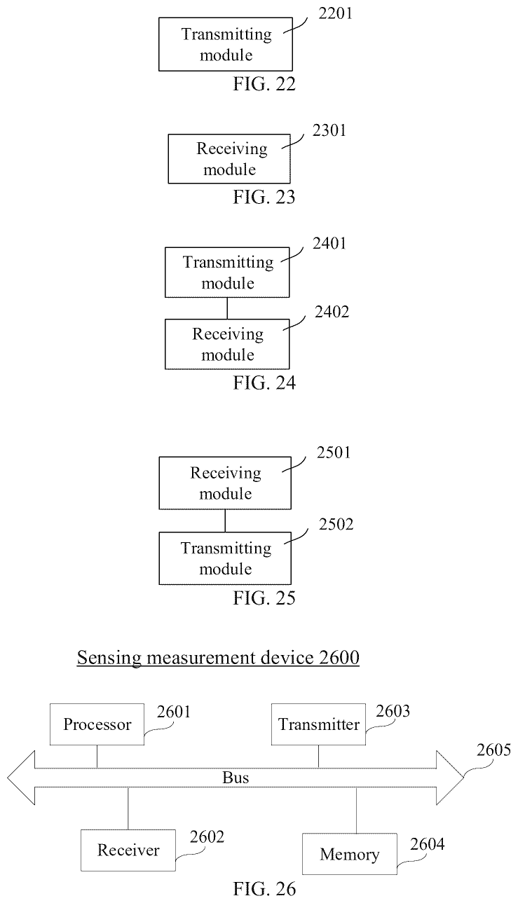

FIG. 22 is a block diagram of an apparatus for sensing measurement according to some embodiments of the present disclosure. The apparatus is applicable to a sensing initiator, and includes:
a transmitting module 2201, configured to transmit a Sync field in a parallel coordinated monostatic measurement, wherein the Sync field is used to trigger a sensing responder to transmit a monostatic PPDU.

In some embodiments, the Sync field includes at least one Sync subfield, wherein the at least one Sync subfield is directionally transmitted to the sensing responder corresponding to the Sync subfield.

In some embodiments, the Sync field is used to trigger at least two sensing responders to concurrently transmit the monostatic PPDU.

In some embodiments, the Sync field is used to trigger the sensing responder to transmit the monostatic PPDU after a first space.

In some embodiments, the Sync field is carried in a first frame.

In some embodiments, the first frame is an EDMG multi-static sensing PPDU.

In some embodiments, the first frame includes a first type field, wherein a value of the first type field indicates that the first frame is used for the parallel coordinated monostatic measurement.

In some embodiments, the first frame is an EDMG multi-static sensing PPDU, and the first type field is a Sensing Type field in an EDMG-Header-A field.

In summary, the Sync field triggers the sensing responder to transmit the monostatic PPDU, the timing problem in the parallel coordinated monostatic sensing measurement is solved.

FIG. 23 is a block diagram of an apparatus for sensing measurement according to some embodiments of the present disclosure. The apparatus is applicable to a sensing responder, and includes:
a receiving module 2301, configured to receive a Sync field in a parallel coordinated monostatic measurement, wherein the Sync field is used to trigger the sensing responder to transmit a monostatic PPDU.

In some embodiments, the receiving module 2301 is configured to receive a Sync subfield corresponding to the sensing responder in the parallel coordinated monostatic measurement.

In some embodiments, the Sync field is used to trigger at least two sensing responders to concurrently transmit the monostatic PPDU.

In some embodiments, the Sync field is used to trigger the sensing responder to transmit the monostatic PPDU after a first space.

In some embodiments, the Sync field is carried in a first frame. In some embodiments, the first frame is an EDMG multi-static sensing PPDU.

In some embodiments, the first frame includes a first type field, wherein a value of the first type field indicates that the first frame is used for the parallel coordinated monostatic measurement. In some embodiments, the first frame is an EDMG multi-static sensing PPDU, and the first type field is a Sensing Type field in an EDMG-Header-A field.

In some embodiments, the first frame includes a first number field, wherein a value of the first number field indicates a number of Sync subfields in the first frame. In some embodiments, the first frame is an EDMG multi-static sensing PPDU, and the first number field is a Multi-static Sensing NSTA field in an EDMG-Header-A field.

In summary, the Sync field triggers the sensing responder to transmit the monostatic PPDU, the timing problem in the parallel coordinated monostatic sensing measurement is solved.

FIG. 24 is a block diagram of an apparatus for sensing measurement according to some embodiments of the present disclosure. The apparatus is applicable to a sensing initiator, and includes:
a transmitting module 2401, configured to transmit a sensing request frame to at least one sensing responder using a first MCS in a parallel coordinated monostatic measurement; and
a receiving module 2402, configured to receive a sensing response frame transmitted by the at least one sensing responder using the first MCS, wherein the first MCS is an MCS specified in a protocol.

In some embodiments, the first MCS is any of an MCS 0 to an MCS 5, and an MCS 7 to an MCS 10.

In some embodiments, the transmitting module 2401 is configured to transmit an i^{th} sensing request frame at an i^{th} time after a transmission end time of an (i−1)^{th} sensing request frame in response to a frame transmission error, wherein a duration between the i^{th} time and the transmission end time is a duration specified in the protocol, i is a positive integer greater than 1, and the (i−1)^{th} sensing request frame and the i^{th} sensing request frame are transmitted using the first MCS.

In some embodiments, the duration between the i^{th} time and the transmission end time includes two first intervals and a reserved transmission duration of the sensing response frame.

In some embodiments, the frame transmission error is caused due to a failure to receive the (i−1)^{th} sensing request frame by an (i−1)^{th} sensing responder.

In some embodiments, the frame transmission error is caused due to a failure to receive an (i−1)^{th} sensing response frame from an (i−1)^{th} sensing responder.

In some embodiments, in a case that the sensing responder is an enhanced directional multi-gigabit (EDMG) station (STA), an EDMG physical layer protocol data unit (PPDU) carrying the sensing request frame and the sensing response frame meets one of the following conditions or any combinations thereof:
the EDMG PPDU is a non-EDMG single carrier (SC) mode PPDU or a non-EDMG control mode PPDU;
the EDMG PPDU occupies a contiguous 2.16 GHz channel; and
the EDMG PPDU uses a normal guard interval.

In summary, the sensing initiator transmits the Sync field to trigger the sensing responder to transmit the monostatic PPDU, such that the timing problem in the parallel coordinated monostatic sensing measurement is solved.

FIG. 25 is a block diagram of an apparatus for sensing measurement according to some embodiments of the present disclosure. The apparatus is applicable to a sensing responder, and includes:
a receiving module 2501, configured to receive a sensing request frame transmitted by a sensing initiator using a first MCS in a parallel coordinated monostatic measurement; and
a transmitting module 2502, configured to transmit a sensing response frame to the sensing initiator using the first MCS, wherein the first MCS is an MCS specified in a protocol.

In some embodiments, the first MCS is any of an MCS 0 to an MCS 5, and an MCS 7 to an MCS 10.

In some embodiments, in a case that the sensing responder is an enhanced directional multi-gigabit (EDMG) station (STA), an EDMG physical layer protocol data unit (PPDU) carrying the sensing request frame and the sensing response frame meets one of the following conditions or any combinations thereof:
the EDMG PPDU is a non-EDMG single carrier (SC) mode PPDU or a non-EDMG control mode PPDU;
the EDMG PPDU occupies a contiguous 2.16 GHz channel; and
the EDMG PPDU uses a normal guard interval.

In summary, the sensing responder receives the Sync field to trigger the sensing responder to transmit the monostatic PPDU, such that the timing problem in the parallel coordinated monostatic sensing measurement is solved.

It should be noted that, in the case that the apparatus according to the above embodiments implements the functions thereof, the division of the functional modules is merely exemplary. In practical application, the above functions may be assigned to different functional modules according to actual needs. That is, the internal structure of the device may be divided into different functional modules, so as to implement all or a part of the above functions.

With regard to the apparatus in the above embodiments, the specific manner in which each module performs the operation has been described in detail in the embodiments related to the method and will not be described in detail herein.

FIG. 26 is a schematic structural diagram of a sensing measurement device (a sensing initiator and/or a sensing responder) according to some embodiments of the present disclosure. The sensing measurement device 2600 includes: a processor 2601, a receiver 2602, a transmitter 2603, a memory 2604, and a bus 2605.

The processor 2601 includes one or more processing cores, and achieves various functional applications and information processing by running software programs and modules.

The receiver 2602 and the transmitter 2603 are practiced as a communication assembly. The communication assembly is a communication chip.

The memory 2604 is connected to the processor 2601 over the bus 2605. The memory 2604 is configured to store one or more instructions, and the processor 2601, when loading and executing the one or more instructions, is caused to perform various processes in the above method embodiments.

In addition, the memory 2604 is practiced by any type of volatile or non-volatile storage device or combinations thereof. The volatile or non-volatile storage device includes but is not limited to a disk or optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

Some embodiments of the present disclosure further provide a computer-readable storage medium storing one or more computer programs, wherein the one or more computer programs, when loaded and run by a sensing measurement device, cause the sensing measurement device (a sensing initiator and/or a sensing responder) to perform the above method for sensing measurement.

In some embodiments, the computer-readable storage medium is a ROM, a Random-Access Memory (RAM), a solid state drive (SSD), or a compact disc. The RAM is a resistance random access memory (ReRAM) or a dynamic random access memory (DRAM).

Some embodiments of the present disclosure further provide a chip. The chip includes programmable logic circuitry and/or program instructions, wherein a sensing measurement device equipped with the chip, when running, is caused to perform the above method for sensing measurement.

Some embodiments of the present disclosure further provide a computer program product or a computer program. The computer program product or the computer program includes one or more computer instructions stored in a computer-readable storage medium, wherein a sensing measurement device, when reading the one or more computer instructions from the computer-readable storage medium and executing the one or more computer instructions, is caused to perform the above method for sensing measurement.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for sensing measurement, applicable to a sensing initiator, the method comprising:
transmitting a sensing request frame to at least one sensing responder using a first modulation and coding scheme (MCS) in a parallel coordinated monostatic measurement; and
receiving a sensing response frame transmitted by the at least one sensing responder using the first MCS, wherein the first MCS is an MCS specified in a protocol.

2. The method according to claim 1, wherein transmitting the sensing request frame to the at least one sensing responder using the first MCS comprises:
transmitting an i^{th} sensing request frame at an i^{th} time after a transmission end time of an (i−1)^{th} sensing request frame in response to a frame transmission error, wherein a duration between the i^{th} time and the transmission end time is a duration specified in the protocol, i is a positive integer greater than 1, and the (i−1)^{th} sensing request frame and the i^{th} sensing request frame are transmitted using the first MCS.

3. The method according to claim 2, wherein the duration between the i^{th} time and the transmission end time comprises two first intervals and a reserved transmission duration of the sensing response frame.

4. The method according to claim 2, further comprising:
upon transmitting the sensing request frame to one of the at least one sensing responder, starting, in response to not receiving the sensing response frame within a first duration, to transmit a next sensing request frame to another of the at least one sensing responder within a second duration after transmission end of the sensing request frame.

5. The method according to claim 4, wherein the first duration is a Short Interframe Space (SIFS) or a point coordination function (PCF) interframe space (PIFS) duration, and the second duration comprises two SIFS durations and a reserved transmission duration of the sensing response frame.

6. The method according to claim 4, wherein interaction times between the sensing initiator and the at least one sensing responder are the same.

7. The method according to claim 1, wherein in a case that the sensing responder is an enhanced directional multi-gigabit (EDMG) station (STA), an EDMG physical layer protocol data unit (PPDU) carrying the sensing request frame and the sensing response frame meets one or more of the following:
the EDMG PPDU is a non-EDMG single carrier (SC) mode PPDU or a non-EDMG control mode PPDU;
the EDMG PPDU occupies a contiguous 2.16 GHz channel; and
the EDMG PPDU uses a normal guard interval.

8. A sensing initiator, comprising:
a processor;
a transceiver connected to the processor; and
a memory storing one or more executable instructions, which when executed by the processor, cause the sensing initiator to:
transmit a sensing request frame to at least one sensing responder using a first modulation and coding scheme (MCS) in a parallel coordinated monostatic measurement; and
receive a sensing response frame transmitted by the at least one sensing responder using the first MCS, wherein the first MCS is an MCS specified in a protocol.

9. The sensing initiator according to claim 8, wherein the one or more executable instructions, which when executed by the processor, further cause the sensing initiator to:
transmit an i^{th} sensing request frame at an i^{th} time after a transmission end time of an (i−1)^{th} sensing request frame in response to a frame transmission error, wherein a duration between the i^{th} time and the transmission end time is a duration specified in the protocol, i is a positive integer greater than 1, and the (i−1)^{th} sensing request frame and the i^{th} sensing request frame are transmitted using the first MCS.

10. The sensing initiator according to claim 9, wherein the duration between the i^{th} time and the transmission end time comprises two first intervals and a reserved transmission duration of the sensing response frame.

11. The sensing initiator according to claim 9, wherein the one or more executable instructions, which when executed by the processor, further cause the sensing initiator to:
upon transmitting the sensing request frame to one of the at least one sensing responder, start, in response to not receiving the sensing response frame within a first duration, to transmit a next sensing request frame to another of the at least one sensing responder within a second duration after transmission end of the sensing request frame.

12. The sensing initiator according to claim 11, wherein the first duration is a Short Interframe Space (SIFS) or a point coordination function (PCF) interframe space (PIFS) duration, and the second duration comprises two SIFS durations and a reserved transmission duration of the sensing response frame.

13. The sensing initiator according to claim 11, wherein interaction times between the sensing initiator and the at least one sensing responder are the same.

14. The sensing initiator according to claim 8, wherein in a case that the sensing responder is an enhanced directional multi-gigabit (EDMG) station (STA), an EDMG physical layer protocol data unit (PPDU) carrying the sensing request frame and the sensing response frame meets one or more of the following:
the EDMG PPDU is a non-EDMG single carrier (SC) mode PPDU or a non-EDMG control mode PPDU;
the EDMG PPDU occupies a contiguous 2.16 GHz channel; and
the EDMG PPDU uses a normal guard interval.

15. A non-transitory computer-readable storage medium, storing one or more computer programs, which when executed by a processor causes a sensing initiator to:
transmit a sensing request frame to at least one sensing responder using a first modulation and coding scheme (MCS) in a parallel coordinated monostatic measurement; and
receive a sensing response frame transmitted by the at least one sensing responder using the first MCS, wherein the first MCS is an MCS specified in a protocol.

16. The non-transitory computer-readable storage medium according to claim 15, wherein the one or more computer programs, which when executed by the processor further causes the sensing initiator to:
transmit an i^{th} sensing request frame at an i^{th} time after a transmission end time of an (i−1)^{th} sensing request frame in response to a frame transmission error, wherein a duration between the i^{th} time and the transmission end time is a duration specified in the protocol, i is a positive integer greater than 1, and the (i−1)^{th} sensing request frame and the i^{th} sensing request frame are transmitted using the first MCS.

17. The non-transitory computer-readable storage medium according to claim 16, wherein the duration between the i^{th} time and the transmission end time comprises two first intervals and a reserved transmission duration of the sensing response frame.

18. The non-transitory computer-readable storage medium according to claim 16, wherein the one or more computer programs, which when executed by the processor further causes the sensing initiator to:
upon transmitting the sensing request frame to one of the at least one sensing responder, start, in response to not receiving the sensing response frame within a first duration, to transmit a next sensing request frame to another of the at least one sensing responder within a second duration after transmission end of the sensing request frame.

19. The non-transitory computer-readable storage medium according to claim 18, wherein the first duration is a Short Interframe Space (SIFS) or a point coordination function (PCF) or a point coordination function (PCF) interframe space (PIFS) duration, and the second duration comprises two SIFS durations and a reserved transmission duration of the sensing response frame.

20. The non-transitory computer-readable storage medium according to claim 15, wherein interaction times between the sensing initiator and the at least one sensing responder are the same.
